(19) United States
(12) Patent Application Publication
(10) Pub. No.: US 2025/0227341 A1
(43) Pub. Date: Jul. 10, 2025

(54) DISPLAY DEVICE

(71) Applicant: LG ELECTRONICS INC., Seoul (KR)

(72) Inventors: Saem PARK, Seoul (KR); Jeonghyu YANG, Seoul (KR); Jongchan KIM, Seoul (KR); Changsun LEEM, Seoul (KR)

(73) Assignee: LG ELECTRONICS INC., Seoul (KR)

(21) Appl. No.: 18/853,309

(22) PCT Filed: Apr. 5, 2022
(86) PCT No.: PCT/KR2022/004844

§ 371 Date: Oct. 1, 2024

(51) Int. Cl. H04N 21/482; H04N 21/462

(52) U.S. Cl. CPC H04N 21/482; H04N 21/462

(57) ABSTRACT

The present disclosure provides a display device comprising: a user input interface unit which receives an input of a user-customized channel generation command from a remote control device; a processor which obtains at least one user-preferred category in response to the user-customized channel generation command, adds a content list including at least one content to each of the obtained at least one user-preferred category, and matches the user-preferred category including the content list to a first user-customized channel and generates same to generate a user-customized channel list; and a display unit which displays the user-customized channel list.

### TECHNICAL FIELD

The present disclosure relates to a display device and a channel providing method capable of providing user-preferred content and user-customized channels.

### BACKGROUND ART

In general, users who watch display devices use a remote control device that can remotely control the display device.

Control of display devices that receive existing broadcast channels and display content has been done in the form of displaying broadcast content being received through a channel assigned to a certain number when the channel is selected.

However, recently, as various content providers provide a lot of content in addition to broadcast content, it is difficult to meet the needs of consumers to easily select the content they want to watch with this search method.

Therefore, in order for users to easily select the content they want to watch, a user-customized channel setting function is needed that allows users to configure channels in the desired category and configure a list from the content provided by the content provider on each channel.

And when switching to a user-customized channel, there is an increasing need to provide a function that allows convenient browsing of the content configured in the channel.

In addition, in the past, in order to view a large amount of content provided by various content providers, it was difficult for consumers to immediately view the content they want because they had to first select and run a dedicated browser or player program for each content provider and then search and select the content.

Therefore, there is an increasing need to provide a display device that can immediately play and display the selected content without any separate operation when selecting content configured in a user-customized channel, or can display other content configured in the user-customized channel without any separate operation when playback of a specific content configured in the user-customized channel is finished.

### DISCLOSURE

### Technical Problem

The problem that this disclosure aims to solve is to provide a display device and a channel providing method that can generate a channel by a user's preferred category or generate a user-customized channel that matches the frequency band or IP address of a content provider preferred by the user.

In addition, the problem that this disclosure aims to solve is to provide a display device and a channel providing method that can generate a user-customized channel by generating a user-customized channel and adding a user-preferred content list to be played on the channel.

In addition, the problem that this disclosure aims to solve is to provide a display device and a channel providing method that can automatically generate a user-customized channel composed of contents or categories preferred by the user by analyzing the user's viewing pattern.

In addition, the problem that this disclosure aims to solve is to provide a display device and a channel providing method that can receive content, category, or channel information from a specific display device or a specific server related to the user and generate a user-customized channel based on the content, category, or channel information received.

In addition, the problem that the present disclosure seeks to solve is to provide a display device and a channel providing method that enable switching of user-customized channels and movement of content within a channel conveniently using up, down, left, and right buttons of a remote control device.

In addition, the problem that the present disclosure seeks to solve is to provide a display device and a method that have a function of displaying selected content without a separate operation when content configured in a user-customized channel is selected.

In addition, the problem that the present disclosure seeks to solve is to provide a display device and a method that have a function of displaying other content configured in a user-customized channel without a separate operation when playback of specific content configured in a user-customized channel is finished.

### Technical Solution

A display device according to an embodiment of the present disclosure comprises a user input interface configured to receive a user-customized channel generation command from a remote control device, a processor configured to acquire at least one user-preferred category in response to the user-customized channel generation command, add a content list including at least one content to each of the acquired at least one user-preferred category, and generate a user-customized channel list by matching and generating the user-preferred category including the content list to a first user-customized channel, and a display configured to display the user-customized channel list.

A display device according to an embodiment of the present disclosure comprises a processor configured to acquire at least one user-preferred content provider in response to the user-customized channel generation command, generate by matching each of the acquired at least one user-preferred content provider with at least one second user-customized channel, receive a content list from a server of each of the at least one user-preferred content providers, add the received content list to each of the at least one second user-customized channel, and cause the user-customized channel list to include at least one second user-customized channel and a content list added to each of the at least one second user-customized channel.

A display device according to an embodiment of the present disclosure comprises a processor configured to generate an automatic recommendation channel, acquire a list associated with a user ID, acquire a content list including at least one content based on at least one ID included in the list associated with the user ID, add the acquired content list to the automatic recommendation channel, and cause the user-customized channel list to include the automatic recommendation channel and the content list added to the automatic recommendation channel.

A display device according to an embodiment of the present disclosure comprises a processor configured to generate the content list by sorting at least one news content preferred by a user in order of latest when the at least one user-preferred category is news.

A display device according to an embodiment of the present disclosure comprises a processor configured to generate the content list including at least one drama content based on a drama genre preferred by a user, when the at least one user-preferred category is a drama.

A display device according to an embodiment of the present disclosure comprises a processor configured to generate the content list including the drama content from a last viewing point of a drama watched by the user to a current broadcasted episode, if the drama content included in the content list is the drama content previously watched by the user, and the watched drama content consists of a plurality of episodes.

A display device according to an embodiment of the present disclosure comprises a processor configured to generate the content list including one or more sports contents related to a user's preferred team or sport, if the at least one user-preferred category is a sport.

A display device according to an embodiment of the present disclosure comprises a processor configured to acquire a content change command from the remote control device through the user input interface, determine whether the acquired content change command is a channel change command or a content move command, move to a channel corresponding to the channel change command and play one content from a content list of the moved channel, or move to a content corresponding to the content move command and play the moved content.

A display device according to an embodiment of the present disclosure comprises a processor configured to determine the content change command as a channel change command if the content change command is an up movement command corresponding to an up movement button input of the remote control device or a down movement command corresponding to a down movement button input of the remote control device.

A display device according to an embodiment of the present disclosure comprises a processor configured to determines the content change command as a content move command if the content change command is a left movement command corresponding to a left movement button input of the remote control device or a right movement command corresponding to a right movement button input of the remote control device.

A display device according to an embodiment of the present disclosure comprises a processor configured to move to a channel corresponding to the channel change command and play a content corresponding to a highest priority among a content list of the moved channel.

A display device according to an embodiment of the present disclosure comprises a processor configured to play a live sports content with a highest priority among the content list of the moved channel, if a user-preferred category of the moved channel is sport.

A display device according to an embodiment of the present disclosure comprises a processor configured to determine whether a channel adjacent to a channel on which content is being played is a user-preferred content provider channel, and if the channel adjacent is a user-preferred content provider, execute an application of the content provider of the channel adjacent in a background.

A display device according to an embodiment of the present disclosure comprises a processor configured to perform automatic login for a user ID in the application running in the background and perform preload for each content in a content list of the channel adjacent.

### Advantageous Effects

According to an embodiment of the present disclosure, the display device can generate channels by categories preferred by the user, and can generate a user-customized channel by adding a content list to be played in the generated channel.

According to an embodiment of the present disclosure, the display device can conveniently move the switching of the user-customized channel and the movement of content within the channel by using the up, down, left, and right buttons of the remote control device.

According to an embodiment of the present disclosure, the display device can improve the channel list composed of only conventional broadcast channels and can configure a user-customized channel list including content provided from broadcast channels and content providers, and can search and play the content.

According to an embodiment of the present disclosure, when a channel is selected from the user-customized channel list, the display device can display the content of the selected channel without a separate operation.

### DESCRIPTION OF DRAWINGS

FIG. 1 is a block diagram illustrating a configuration of a display device according to an embodiment of the present disclosure.

FIG. 2 is a block diagram of a remote control device according to an embodiment of the present disclosure.

FIG. 3 shows an example of an actual configuration of a remote control device according to an embodiment of the present disclosure.

FIG. 4 shows an example of utilizing a remote control device according to an embodiment of the present disclosure.

FIG. 5 is a diagram for explaining a conventional channel list according to an embodiment of the present disclosure.

FIG. 6 is a flowchart for explaining a user-customized channel providing method according to an embodiment of the present disclosure.

FIG. 7 is a diagram for explaining a user-customized channel list according to an embodiment of the present disclosure.

FIG. 8 is a flowchart for explaining a user-customized channel providing method according to an embodiment of the present disclosure.

FIG. 9 is a diagram for explaining a user-customized channel providing method according to an embodiment of the present disclosure.

FIG. 10 is a flowchart for explaining a user-customized channel providing method according to an embodiment of the present disclosure.

FIG. 11 is a flowchart for explaining a user-customized channel providing method according to an embodiment of the present disclosure.

### BEST MODE

Hereinafter, embodiments of the present disclosure will be described in detail with reference to the drawings. The suffixes “module” and “unit or portion” for components used in the following description are merely provided only for facilitation of preparing this specification, and thus they are not granted a specific meaning or function.

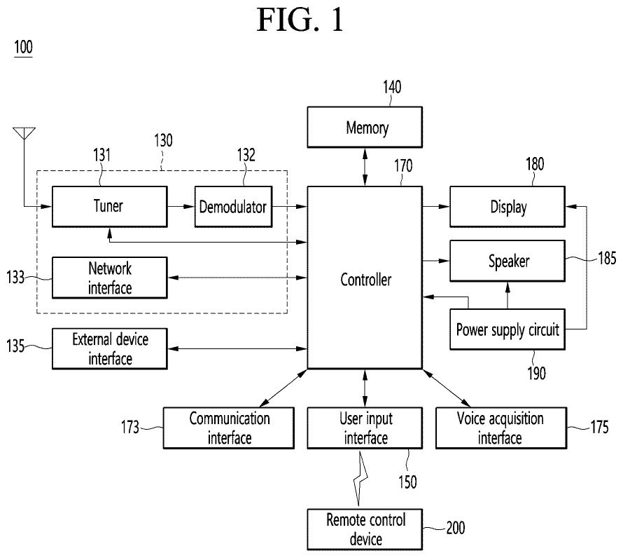

FIG. 1 is a block diagram showing a configuration of a display device according to an embodiment of the present disclosure.

Referring to FIG. 1, a display device 100 may include a broadcast receiver 130, an external device interface 135, a memory 140, a user input interface 150, a controller 170, a communication interface 173, a display 180, a speaker 185, and a power supply circuit 190.

The broadcast receiver 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The network interface 133 may provide an interface for connecting the display device 100 to a wired/wireless network including an Internet network. The network interface 133 may transmit or receive data to or from other users or other electronic devices through a connected network or another network linked to the connected network.

The network interface 133 may access a predetermined web page through the connected network or the other network linked to the connected network. That is, it is possible to access a predetermined web page through a network, and transmit or receive data to or from a corresponding server.

In addition, the network interface 133 may receive content or data provided by a contents provider or a network operator. That is, the network interface 133 may receive content such as movies, advertisements, games, VOD, and broadcast signals and information related thereto provided from a contents provider or a network provider through a network.

In addition, the network interface 133 may receive update information and update files of firmware provided by the network operator, and may transmit data to an Internet or contents provider or a network operator.

The network interface 133 may select and receive a desired application from among applications that are open to the public through a network.

The external device interface 135 may receive an application or a list of applications in an external device adjacent thereto, and transmit the same to the controller 170 or the memory 140.

The external device interface 135 may provide a connection path between the display device 100 and an external device. The external device interface 135 may receive one or more of images and audio output from an external device connected to the display device 100 in a wired or wireless manner, and transmit the same to the controller 170. The external device interface 135 may include a plurality of external input terminals. The plurality of external input terminals may include an RGB terminal, one or more High Definition Multimedia Interface (HDMI) terminals, and a component terminal.

The image signal of the external device input through the external device interface 135 may be output through the display 180. The audio signal of the external device input through the external device interface 135 may be output through the speaker 185.

The external device connectable to the external device interface 135 may be any one of a set-top box, a Blu-ray player, a DVD player, a game machine, a sound bar, a smartphone, a PC, a USB memory, and a home theater, but this is only an example.

In addition, a part of content data stored in the display device 100 may be transmitted to a selected user among a selected user or a selected electronic device among other users or other electronic devices registered in advance in the display device 100.

The memory 140 may store programs for signal processing and control of the controller 170, and may store images, audio, or data signals, which have been subjected to signal-processed.

In addition, the memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The display device 100 may play a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 100.

In addition, the controller 170 may control the display device 100 by a user command input through the user input interface 150 or an internal program and connect to a network to download an application a list of applications or applications desired by the user to the display device 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface or an image which is stored in the memory 140 to be displayed on the display 180. In this case, an image being displayed on the display 180 may be a still image or a moving image, and may be a 2D image or a 3D image.

In addition, the controller 170 may allow content stored in the display device 100, received broadcast content, or external input content input from the outside to be played, and the content may have various forms such as a broadcast image, an external input image, an audio file, still images, accessed web screens, and document files.

The communication interface 173 may communicate with an external device through wired or wireless communication. The communication interface 173 may perform short range communication with an external device. To this end, the communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi(Wireless-Fidelity), Wi-Fi Direct, and Wireless USB (Wireless Universal Serial Bus) technologies. The communication interface 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, another display device 100 may be a wearable device (e.g., a smartwatch, smart glasses or a head mounted display (HMD), a mobile terminal such as a smart phone, which is able to exchange data (or interwork) with the display device 100 according to the present disclosure. The communication interface 173 may detect (or recognize) a wearable device capable of communication around the display device 100. Furthermore, when the detected wearable device is an authenticated device to communicate with the display device 100 according to the present disclosure, the controller 170 may transmit at least a portion of data processed by the display device 100 to the wearable device through the communication interface 173. Therefore, a user of the wearable device may use data processed by the display device 100 through the wearable device.

The voice acquisition interface 175 can acquire audio. The voice acquisition interface 175 can include at least one microphone (not shown) and can acquire audio around the display device 100 through the microphone (not shown).

The display 180 may convert image signals, data signals, and OSD signals processed by the controller 170, or image signals or data signals received from the external device interface 135 into R, G, and B signals, and generate drive signals.

Meanwhile, since the display device 100 shown in FIG. 1 is only an embodiment of the present disclosure, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 1, the display device 100 may receive an image through the network interface 133 or the external device interface 135 without a tuner 131 and a demodulator 132 and play the same.

For example, the display device 100 may be divided into an image processing device, such as a set-top box, for receiving broadcast signals or content according to various network services, and a content playback device that plays content input from the image processing device.

In this case, an operation method of the display device according to an embodiment of the present disclosure will be described below may be implemented by not only the display device 100 as described with reference to FIG. 1 and but also one of an image processing device such as the separated set-top box and a content playback device including the display 180 and the speaker 185.

The audio output interface 185 receives a signal processed by the controller 170 and outputs it as voice.

The power supply circuit 190 supplies the corresponding power to the entire display device 100. In particular, power can be supplied to the controller 170 that can be implemented in the form of a system on chip (SOC), the display 180 for displaying images, and the audio output interface 185 for audio output.

Specifically, the power supply circuit 190 can be equipped with a converter that converts AC power into DC power and a dc/dc converter that converts the level of the DC power.

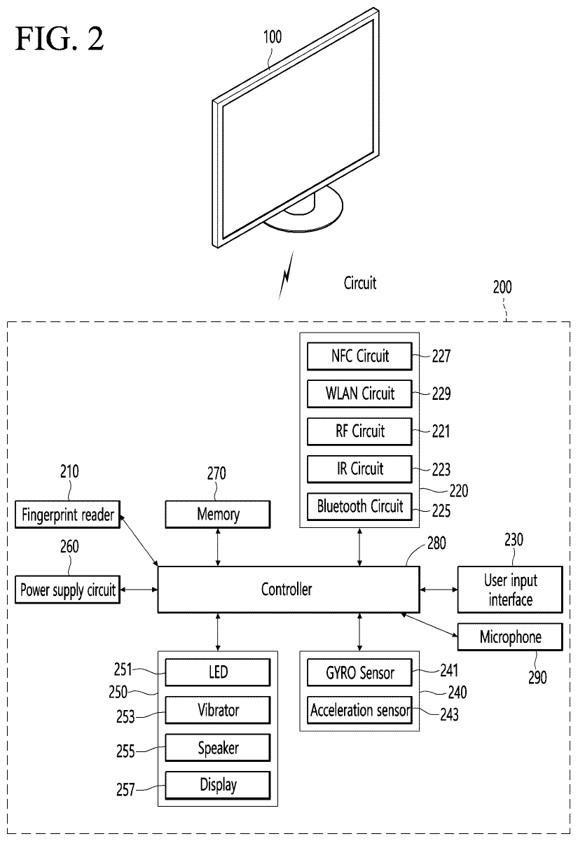

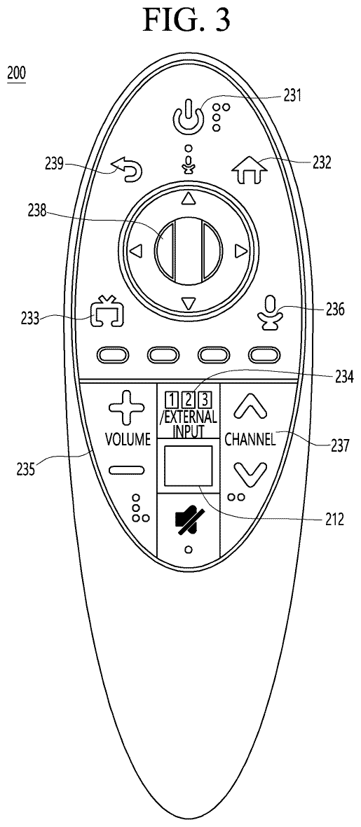

Next, a remote control device according to an embodiment of the present disclosure will be described with reference to FIGS. 2 to 3.

FIG. 2 is a block diagram of a remote control device according to an embodiment of the present disclosure, and FIG. 3 shows an actual configuration example of a remote control device 200 according to an embodiment of the present disclosure.

First, referring to FIG. 2, the remote control device 200 may include a fingerprint reader 210, a wireless communication circuit 220, a user input interface 230, a sensor 240, an output interface 250, a power supply circuit 260, a memory 270, a controller 280, and a microphone 290.

Referring to FIG. 2, the wireless communication circuit 220 may transmit and receive signals to and from any one of display devices according to embodiments of the present disclosure described above.

The remote control device 200 may include an RF circuit 221 capable of transmitting and receiving signals to and from the display device 100 according to the RF communication standard, and an IR circuit 223 capable of transmitting and receiving signals to and from the display device 100 according to the IR communication standard. In addition, the remote control device 200 may include a Bluetooth circuit 225 capable of transmitting and receiving signals to and from the display device 100 according to the Bluetooth communication standard. In addition, the remote control device 200 may include an NFC circuit 227 capable of transmitting and receiving signals to and from the display device 100 according to the NFC (near field communication) communication standard, and a WLAN circuit 229 capable of transmitting and receiving signals to and from the display device 100 according to the wireless LAN (WLAN) communication standard.

In addition, the remote control device 200 may transmit a signal containing information on the movement of the remote control device 200 to the display device 100 through the wireless communication circuit 220.

In addition, the remote control device 200 may receive a signal transmitted by the display device 100 through the RF circuit 221, and transmit a command regarding power on/off, channel change, volume adjustment, or the like to the display device 100 through the IR circuit 223 as necessary.

The user input interface 230 may include a keypad, a button, a touch pad, a touch screen, or the like. The user may input a command related to the display device 100 to the remote control device 200 by operating the user input interface 230. When the user input interface 230 includes a hard key button, the user may input a command related to the display device 100 to the remote control device 200 through a push operation of the hard key button. Details will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back-play button 239.

The fingerprint recognition button 212 may be a button for recognizing a user's fingerprint. In one embodiment, the fingerprint recognition button 212 may enable a push operation, and thus may receive a push operation and a fingerprint recognition operation. The power button 231 may be a button for turning on/off the power of the display device 100. The home button 232 may be a button for moving to the home screen of the display device 100. The live button 233 may be a button for displaying a real-time broadcast program. The external input button 234 may be a button for receiving an external input connected to the display device 100. The volume control button 235 may be a button for adjusting the level of the volume output by the display device 100. The voice recognition button 236 may be a button for receiving a user's voice and recognizing the received voice. The channel change button 237 may be a button for receiving a broadcast signal of a specific broadcast channel. The OK button 238 may be a button for selecting a specific function, and the back-play button 239 may be a button for returning to a previous screen.

A description will be given referring again to FIG. 2.

When the user input interface 230 includes a touch screen, the user may input a command related to the display device 100 to the remote control device 200 by touching a soft key of the touch screen. In addition, the user input interface 230 may include various types of input means that may be operated by a user, such as a scroll key or a jog key, and the present embodiment does not limit the scope of the present disclosure.

The sensor 240 may include a gyro sensor 241 or an acceleration sensor 243, and the gyro sensor 241 may sense information regarding the movement of the remote control device 200.

For example, the gyro sensor 241 may sense information about the operation of the remote control device 200 based on the x, y, and z axes, and the acceleration sensor 243 may sense information about the moving speed of the remote control device 200. Meanwhile, the remote control device 200 may further include a distance measuring sensor to sense the distance between the display device 100 and the display 180.

The output interface 250 may output an image or audio signal corresponding to the operation of the user input interface 230 or a signal transmitted from the display device 100. The user may recognize whether the user input interface 230 is operated or whether the display device 100 is controlled through the output interface 250.

For example, the output interface 250 may include an LED 251 that emits light, a vibrator 253 that generates vibration, a speaker 255 that outputs sound, or a display 257 that outputs an image when the user input interface 230 is operated or a signal is transmitted and received to and from the display device 100 through the wireless communication circuit 220.

In addition, the power supply circuit 260 may supply power to the remote control device 200, and stop power supply when the remote control device 200 has not moved for a predetermined time to reduce power consumption. The power supply circuit 260 may restart power supply when a predetermined key provided in the remote control device 200 is operated.

The memory 270 may store various types of programs and application data required for control or operation of the remote control device 200. When the remote control device 200 transmits and receives signals wirelessly through the display device 100 and the RF circuit 221, the remote control device 200 and the display device 100 transmit and receive signals through a predetermined frequency band.

The controller 280 of the remote control device 200 may store and refer to information on a frequency band capable of wirelessly transmitting and receiving signals to and from the display device 100 paired with the remote control device 200 in the memory 270.

The controller 280 may control all matters related to the control of the remote control device 200. The controller 280 may transmit a signal corresponding to a predetermined key operation of the user input interface 230 or a signal corresponding to the movement of the remote control device 200 sensed by the sensor 240 through the wireless communication circuit 220.

Also, the microphone 290 of the remote control device 200 may obtain a speech.

The microphone 290 may include at least one microphone 291 and may acquire voice through the microphone 291.

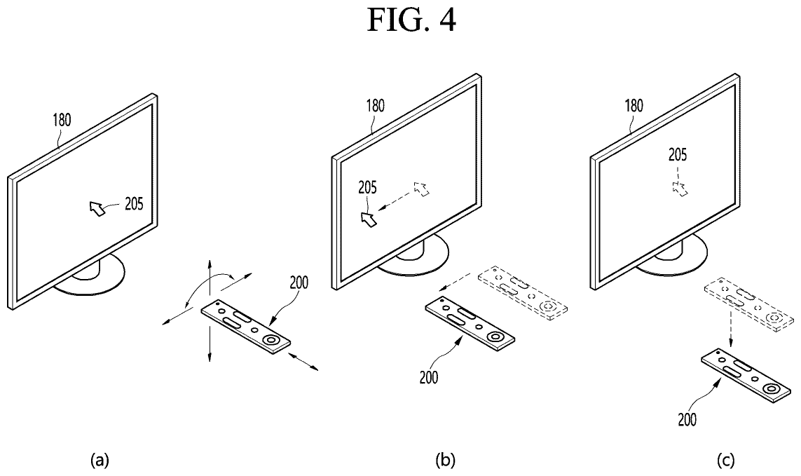

Next, a description will be given referring to FIG. 4.

FIG. 4 shows an example of using a remote control device according to an embodiment of the present disclosure.

In FIG. 4, (a) illustrates that a pointer 205 corresponding to the remote control device 200 is displayed on the display 180.

The user may move or rotate the remote control device 200 up, down, left and right. The pointer 205 displayed on the display 180 of the display device 100 may correspond to the movement of the remote control device 200. As shown in the drawings, the pointer 205 is moved and displayed according to movement of the remote control device 200 in a 3D space, so the remote control device 200 may be called a space remote control device.

In (b) of FIG. 4, it is illustrated that that when the user moves the remote control device 200 to the left, the pointer 205 displayed on the display 180 of the display device 100 moves to the left correspondingly.

Information on the movement of the remote control device 200 detected through a sensor of the remote control device 200 is transmitted to the display device 100. The display device 100 may calculate the coordinates of the pointer 205 based on information on the movement of the remote control device 200. The display device 100 may display the pointer 205 to correspond to the calculated coordinates.

In (c) of FIG. 4, it is illustrated that a user moves the remote control device 200 away from the display 180 while pressing a specific button in the remote control device 200. Accordingly, a selected area in the display 180 corresponding to the pointer 205 may be zoomed in and displayed enlarged.

Conversely, when the user moves the remote control device 200 to be close to the display 180, the selected area in the display 180 corresponding to the pointer 205 may be zoomed out and displayed reduced.

On the other hand, when the remote control device 200 moves away from the display 180, the selected area may be zoomed out, and when the remote control device 200 moves to be close to the display 180, the selected area may be zoomed in.

Also, in a state in which a specific button in the remote control device 200 is being pressed, recognition of up, down, left, or right movements may be excluded. That is, when the remote control device 200 moves away from or close to the display 180, the up, down, left, or right movements are not recognized, and only the forward and backward movements may be recognized. In a state in which a specific button in the remote control device 200 is not being pressed, only the pointer 205 moves according to the up, down, left, or right movements of the remote control device 200.

Meanwhile, the movement speed or the movement direction of the pointer 205 may correspond to the movement speed or the movement direction of the remote control device 200.

Meanwhile, in the present specification, a pointer refers to an object displayed on the display 180 in response to an operation of the remote control device 200. Accordingly, objects of various shapes other than the arrow shape shown in the drawings are possible as the pointer 205. For example, the object may be a concept including a dot, a cursor, a prompt, a thick outline, and the like. In addition, the pointer 205 may be displayed corresponding to any one point among points on a horizontal axis and a vertical axis on the display 180, and may also be displayed corresponding to a plurality of points such as a line and a surface.

Meanwhile, the controller 170 may also be named as a processor 170. In addition, the memory 140 may be named as a storage unit 140. In addition, the communication interface 173 may be named as the communication module 173.

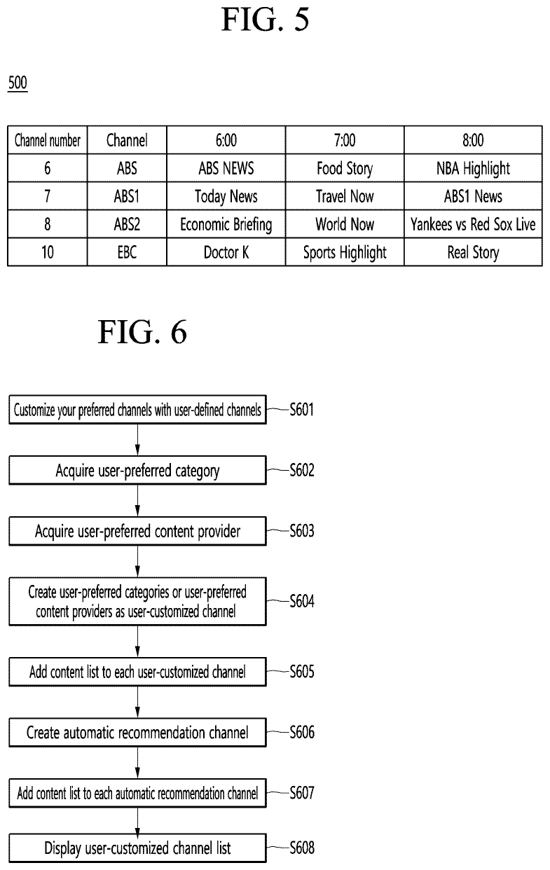

FIG. 5 is a drawing for explaining a conventional channel list according to an embodiment of the present disclosure.

The conventional channel list 500 may be assigned a physical broadcast frequency band or IP address that is assigned to a content provider that supplies content for each predetermined channel number. In addition, when changing a channel of the conventional channel list 500, an adjacent channel may be moved using the channel change button 237 of the remote control device 200.

Meanwhile, each channel of the conventional channel list 500 has content to be played back in advance for each time period.

Therefore, in the conventional channel list, the content provided for each channel is limited, so the user cannot organize the content he or she wants to watch on a single channel, and there is also the problem that the user cannot watch the content he or she wants to watch at a specific time.

FIG. 6 is a flowchart for explaining a method for providing a user-customized channel according to an embodiment of the present disclosure.

The display device 100 can create a user-customized channel. A user-customized channel means created by content category, content provider, or by collecting content that the user wants to view, and a user can add content to each created channel and create a list using the added content.

The processor 170 can receive a generation command for creating a user-customized channel (S601). The processor 170 can receive a user-customized channel generation command from a remote control device 200 through a user input interface 150. A user-preferred category or a user-preferred content provider can be designated for the user-customized channel. The processor 170 can store the designated user-preferred category or user-preferred content provider in the memory 140 so as to correspond to the user-customized channel.

The processor 170 can designate a user-preferred category (S602).

The user-preferred category can be a content category that the user wants to watch, and can include content categories such as news, drama, movie, or sport.

The processor 170 can receive a command for the user to designate a category through the user input interface 150. In addition, the processor 170 can analyze the categories of the content watched by the user to acquire information on the content category preferred by the user.

In addition, the processor 170 can analyze the providers of the content watched by the user to acquire information on the content provider preferred by the user (S603).

The user-preferred content provider (CP, Content Provider) can be a content provider that provides general broadcasting programs or a general public broadcasting content provider, or a content provider that provides an OTT (Over-the-top media service) service.

Meanwhile, a general public broadcasting content provider can provide content using a physical frequency band. In addition, a content provider providing an OTT service can provide content using an IP address.

The processor 170 can receive information about a content provider preferred by a user through the user input interface 150. In addition, the processor 170 can analyze the content providers of the content viewed by the user and acquire the content providers preferred by the user in order of the content providers viewed the most by the user.

Meanwhile, the processor 170 can create a user-customized channel based on a user-preferred category or a user-preferred content provider (S604).

The processor 170 can create a user-customized channel by matching a user-preferred category or a user-preferred content provider.

The processor 170 can assign a user-customized channel number by matching each registered user-customized channel to a predetermined channel number. For example, the processor 170 can assign a predetermined channel number to each user-customized channel based on a channel number registration command input from a user through the user input interface 150.

Meanwhile, the processor 170 can add a content list to each user-customized channel (S605).

The processor 170 may add a content list including at least one content to each user-customized channel based on at least one user-preferred category.

The processor 170 can add a content list including one or more contents preferred by the user to each user-customized channel.

In addition, the processor 170 can update the content list of each user-customized channel at a predetermined time. For example, the processor 170 can update the content list of each user-preferred channel at 4:00 AM every day.

Meanwhile, if the user-customized channel is a user-preferred category, the processor 170 can add a content list including one or more contents preferred by the user based on the user-preferred category.

For example, if the user-preferred category is news, the processor 170 can generate a content list by sorting one or more news contents preferred by the user in order of latest, and add the generated content list to the user-customized channel.

If the user-preferred category is drama, the processor 170 can generate one or more drama contents as a content list based on the drama genre preferred by the user.

Meanwhile, if there is drama content that the user has previously watched and the watched drama contents consist of a plurality of episodes, the processor 170 can generate a content list including drama contents from the last viewing point of the drama watched by the user to the episodes aired so far. The processor 170 can add the generated content list to a user-customized channel.

In addition, for example, if the user-preferred category is sport, the processor 170 can generate a content list including one or more sports contents preferred by the user, and add the generated content list to the user-customized channel.

If the user-preferred category is sport, the processor 170 can generate a content list including one or more sports contents related to a team or sport preferred by the user, and add the generated content list to the user-customized channel.

In addition, the processor 170 can generate a content list by prioritizing live broadcast of sports content or a game of a team preferred by the user.

Meanwhile, the processor 170 can receive a content list from a server (not shown) of the user-preferred content provider through the communication interface 173 or the tuner 131 if the user-customized channel corresponds to a frequency band or IP address specified by the user-preferred content provider. Meanwhile, the processor 170 can store the ID and password of a user who can access the user-preferred content provider and perform automatic login to the server (not shown) of the user-preferred content provider.

Therefore, the processor 170 can add the content list received from the server (not shown) of the user-preferred content provider to the user-preferred channel.

Meanwhile, the processor 170 can create an automatic recommendation channel based on the received information and designate the created automatic recommendation channel as a user-customized channel (S606).

The automatic recommendation channel can mean a channel that the display device 100 automatically recommends even when the user does not directly input a preferred category or preferred content provider.

The processor 170 can create an automatic recommendation channel based on content channel information created on a specific display device or a specific server. The content channel created on a specific display device can be a preferred content list or user-customized channel created from an ID that is in a friend relationship with the user or an ID that is in a following relationship, and can receive information through the communication interface 173.

In addition, the processor 170 can add a content list to each automatic recommendation channel (S607).

In this case, the processor 170 can acquire a list connected to the user ID. The list connected may be a list of friends of the user.

The processor 170 can acquire a content list including at least one content based on at least one ID included in the list related to the user ID. The processor 170 can add the acquired content list to a friend content channel.

Meanwhile, the processor 170 can display the generated user-customized channel list on the display 180 (S608).

For example, the processor 170 can receive a channel display command for displaying the user-customized channel list from the remote control device 200 through the user input interface 150. The processor 170 can display the user-customized channel list on the display 180 in response to the channel display command.

In this case, processor 170 can display a user-customized channel list on display 180 in OSD (On Screen Display), PIP (Picture-in-picture) or screen split mode.

Meanwhile, the processor 170 may insert advertising content between the end time of the first content and the start time of the second content in the content list added to each channel. The processor 170 can display advertising content in various forms such as banner, PIP (Picture-in-picture), full screen, split screen, icon, etc. on the display 180.

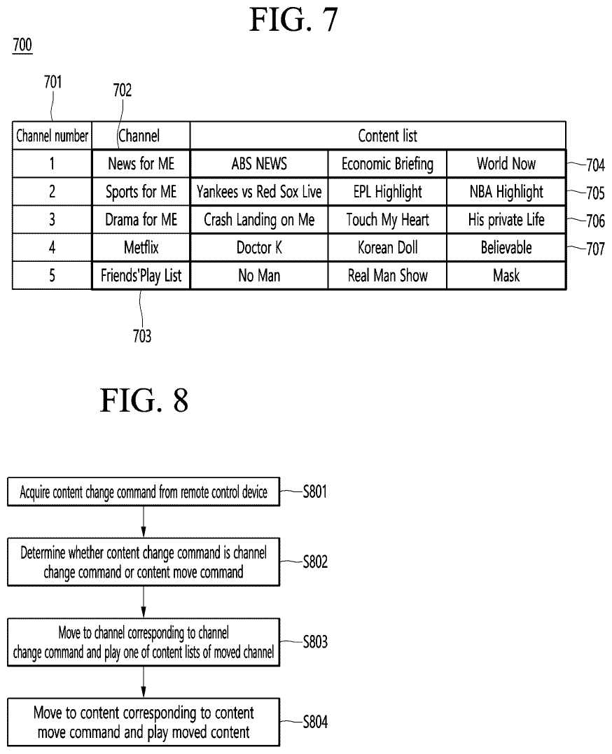

FIG. 7 is a diagram for explaining a user-customized channel list according to an embodiment of the present disclosure.

Referring to FIG. 7, the processor 170 can generate a user-customized channel list 700.

The processor 170 can match and allocate one or more user-customized channels 702 or automatic recommendation channels 703 to at least one channel number 701 and generate a user-customized channel list 700.

The processor 170 can generate a user-customized channel list by adding at least one content to each of at least one user-customized channel.

In addition, the processor 170 can create a user-customized channel list by adding at least one content to at least one automatic recommendation channel.

Meanwhile, the processor 170 can create a content list 704, 705, 706, 707 based on information provided by a user-preferred category or a user-preferred content provider, and add the created content list to at least one user-customized channel 702.

For example, if the user-preferred category is news, the processor 170 can add a news content list 704 including news content sorted in latest order to the user-customized channel.

In addition, for example, if the user-preferred category is sport, the processor 170 can add a sports content list 705 including sports content to the user-customized channel. In addition, if there is live sports content, the processor 170 can create a sports content list 705 with the highest priority and add it to the user-customized channel.

Additionally, for example, if the user-customized category is drama, the processor 170 may add a drama content list 706 including one or more drama contents that reflect the user's drama genre preference information and last viewing point to the user-customized channel.

In addition, for example, if a user-customized channel is matched with a user-preferred content provider, the processor 170 may receive a content list 707 recommended by the user-preferred content provider from the server (not shown) of the user-preferred content provider through the communication interface 173, and add it to the user-customized channel.

In addition, for example, the processor 170 may receive a content list including at least one content preferred by the user based on at least one ID included in the list connected to the user, in the automatic recommendation channel 703, and add it to the user-customized channel. In addition, the processor 170 may add the received content list to the automatic recommendation channel 703.

FIG. 8 is a flowchart illustrating a method for providing a user-customized channel according to an embodiment of the present disclosure.

The processor 170 can acquire a content change command from the remote control device 200 through the user input interface 150 (S801).

The content change command is a command to change content in a user-customized channel list, and can be input by operating the up/down/left/right movement buttons 2310 of the remote control device 200. In addition, the content change command can be a command to change a predetermined channel number from the remote control device 200 to the input channel number.

The processor 170 can determine whether the acquired content change command is a channel change command or a content move command (S802).

For example, if the content change command is an up movement command corresponding to an input of an up movement button 2311 or a down movement command corresponding to an input of a down movement button 2313, the processor 170 can determine the content change command as a channel change command.

In addition, for example, if the content change command is a left movement command corresponding to the input of the left movement button 2312 or a right movement command corresponding to the input of the right movement button 2314, the processor 170 can determine the content change command as a content move command.

In addition, for example, if the content change command is a predetermined channel number input from the remote control device 200, the processor 170 can determine the content change command as a channel change command that changes the channel to the input channel number.

The processor 170 can move to a channel corresponding to the channel change command and play one of the content lists of the moved channel (S803).

The processor 170 can move to a channel corresponding to a channel change command and play the content corresponding to the highest priority in the content list of the moved channel.

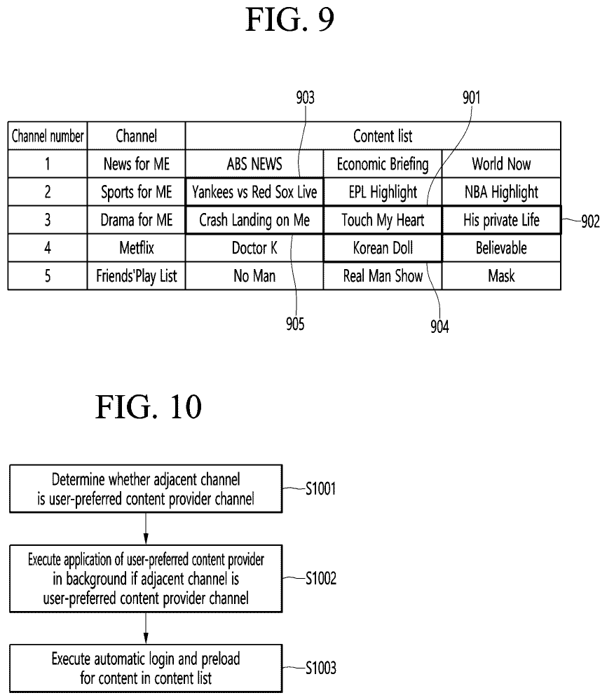

For example, referring to FIG. 9, if an up movement command, which is a channel change command, is input in the currently playing content 901, the processor 170 can move from the current channel number 3 to the nearest adjacent channel number 2, which has a decreasing channel number. In addition, if the user-preferred category of the moved channel is sports, the processor 170 can play the live sports content corresponding to the highest priority in the content list of the moved channel. For example, the processor 170 can play the live sports content 903 corresponding to the highest priority in the content list of the moved channel 2 as a top priority.

Also, for example, referring to FIG. 9, if a down movement command, which is a channel change command, is input in the currently playing content 901, the processor 170 can move from the current channel number 3 to the nearest adjacent channel number 4, which increases the channel number. Also, the processor 170 can play the drama content 904 that the viewer last watched at the highest priority in the content list of the moved channel 4 as the top priority. Therefore, the viewer can continue watching the drama that he or she was watching. Or, if the processor 170 receives a command to watch again from the beginning from the remote control device 200, the processor 170 can play the drama that is being played from the beginning.

Meanwhile, the processor 170 can move to the content corresponding to the content move command and play the moved content (S804).

For example, referring to FIG. 9, when a content move command, which is a right move command, is input from the currently playing content 901, the processor 170 can move from the currently playing content to the next content 902 to be played, and play the moved content 902.

Also, referring to FIG. 9, for example, when a content move command, which is a left move command, is input from the currently playing content 901, the processor 170 can move from the currently playing content to the previous content 905, and play the moved content 905.

Accordingly, the user can conveniently search for desired content in the user-customized channel list by using the up/down/left/right move buttons 2310 of the remote control device 200.

FIG. 10 is a flowchart for explaining a method for providing a user-customized channel according to an embodiment of the present disclosure.

The processor 170 can determine whether a channel adjacent to a channel on which content is being played is a user-preferred content provider channel (S1001).

For example, referring to FIG. 9, the processor 170 can determine whether a channel having a channel number 4 adjacent to channel number 3 of the currently playing content 901 is a user-preferred content provider. If the channel having a channel number 4 is matched with a content provider “Metflix” that provides an OTT (Over-the-top media service) service, the processor 170 can determine that the adjacent channel having a channel number 4 is a user-preferred content provider channel.

Meanwhile, if the adjacent channel is a channel that matches a user-preferred content provider, the processor 170 can execute an application of a content provider that provides content of the corresponding channel in the background (S1002).

For example, if a channel with channel number 4 is a channel that matches a user-preferred content provider, and the preferred content provider is a content provider that provides an OTT (Over-the-top media service) service, the processor 170 can execute the content provider's application in the background (S1002).

Therefore, by executing an application that provides content of an adjacent channel in advance, the application execution time can be shortened when the channel is changed.

Meanwhile, the processor 170 can execute automatic login for the user ID in the executed application and execute preload for each content in the content list of the channel (S1003).

The processor 170 can execute automatic login for the application that executed in the background. The automatic login may be preset in the application.

In addition, the processor 170 may perform a pre-download for each content included in the content list of the channel so that the content can be viewed immediately when the channel is changed.

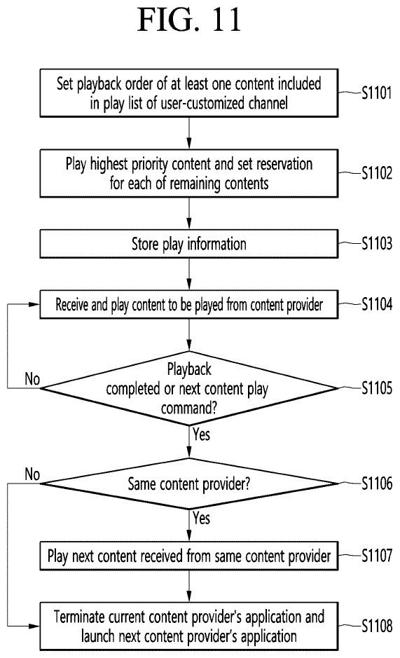

FIG. 11 is a flowchart for explaining a method for providing a user-customized channel according to an embodiment of the present disclosure.

The processor 170 may set the playback order of each of at least one content included in the play list of the user-customized channel (S1101). The play list may mean the content list of the user-customized channel.

The processor 170 may set the playback order of each of at least one content included in the play list. For example, if the category of the user-customized channel is a drama, the processor 170 may set the drama content that the user last watched as the highest priority and set the playback order of the remaining drama contents to correspond to the episode order.

Meanwhile, processor 170 can play the highest priority content and set a reservation for each of the remaining contents (S1102).

The processor 170 can play the highest priority content. And the processor 170 can set a reservation for each of the remaining contents so that the reserved content is played when playback of the highest priority content ends or the next content play command is input.

For example, the processor 170 can play the highest priority content A through the A content provider application. In addition, the processor 170 can set a reservation so that the next priority content B can be played through the B content provider application. Therefore, the content can be played continuously even if the content provider changes.

In addition, the processor 170 can store the play information in the memory 140. The play information can include information about the played content, the play time, the total play time, the user information that input the play command, the content provider information, etc.

Meanwhile, the processor 170 can receive the content to be played from the content provider and play it (S1104).

The processor 170 can receive and play the content to be played based on the frequency band or IP address of the content provider through the communication interface 173 or the tuner 131.

Meanwhile, the processor 170 can determine whether playback of the content to be played has been completed or whether a command to play the next content has been received (S1105).

If the playback of the content to be played has not been completed or before a command to play the next content has been received, the processor 170 can continue playing the content to be played.

Meanwhile, if the playback of content to be played has been completed or a command to play the next content has been input, the processor 170 can determine whether the next content is provided by the same content provider as the content to be played (S1106).

Meanwhile, if the next content is provided by the same content provider, the processor 170 can receive and play the next content from the same content provider (S1107).

Meanwhile, the processor 170 can terminate the application of the current content provider if the next content is not provided by the same content provider. Then, the processor 170 can execute the application of the next content provider. Accordingly, the application of the content provider can be terminated and executed so that the content is continuously played even if the content provider changes.

The above description is merely an example of the technical idea of the present disclosure, and those with ordinary knowledge in the technical field to which the present disclosure belongs may make various modifications and variations without departing from the essential characteristics of the present disclosure.

Therefore, the embodiments disclosed in the present disclosure are not intended to limit the technical idea of the present disclosure but to explain it, and the scope of the technical idea of the present disclosure is not limited by these embodiments.

The protection scope of the present disclosure should be interpreted by the claims below, and all technical ideas within the equivalent scope should be interpreted as being included in the scope of the rights of the present disclosure.

1. A display device, comprising:
a user input interface configured to receive a user-customized channel generation command from a remote control device;
a processor configured to:
acquire at least one user-preferred category in response to the user-customized channel generation command,
add a content list including at least one content to each of the acquired at least one user-preferred category, and
generate a user-customized channel list by matching and generating the user-preferred category including the content list to a first user-customized channel; and
a display configured to display the user-customized channel list,
wherein the processor is further configured to:
acquire a content change command from the remote control device through the user input interface,
determine whether the acquired content change command is a channel change command or a content move command,
move to a channel corresponding to the channel change command and play one content from a content list of the moved channel, or move to a content corresponding to the content move command and play the moved content.

2. The display device of claim 1, wherein the processor is configured to:
acquire at least one user-preferred content provider in response to the user-customized channel generation command,
generate by matching each of the acquired at least one user-preferred content provider with at least one second user-customized channel,
receive a content list from a server of each of the at least one user-preferred content providers,
add the received content list to each of the at least one second user-customized channel, and
cause the user-customized channel list to include at least one second user-customized channel and a content list added to each of the at least one second user-customized channel.

3. The display device of claim 1, wherein the processor is configured to:
generate an automatic recommendation channel,
acquire a list associated with a user ID,
acquire a content list including at least one content based on at least one ID included in the list associated with the user ID,
add the acquired content list to the automatic recommendation channel, and
cause the user-customized channel list to include the automatic recommendation channel and the content list added to the automatic recommendation channel.

4. The display device of claim 1, wherein the processor is configured to:
generate the content list by sorting at least one news content preferred by a user in order of latest when the at least one user-preferred category is news.

5. The display device of claim 1, wherein the processor is configured to:
generate the content list including at least one drama content based on a drama genre preferred by a user, when the at least one user-preferred category is a drama.

6. The display device of claim 5, wherein the processor is configured to:
generate the content list including the drama content from a last viewing point of a drama watched by the user to a current broadcasted episode, if the drama content included in the content list is the drama content previously watched by the user, and the watched drama content consists of a plurality of episodes.

7. The display device of claim 1, wherein the processor is configured to:
generate the content list including one or more sports contents related to a user's preferred team or sport, if the at least one user-preferred category is a sport.

8. (canceled)

9. The display device of claim 1, wherein the processor is configured to:
determine the content change command as a channel change command if the content change command is an up movement command corresponding to an up movement button input of the remote control device or a down movement command corresponding to a down movement button input of the remote control device.

10. The display device of claim 1, wherein the processor is configured to:
determines the content change command as a content move command if the content change command is a left movement command corresponding to a left movement button input of the remote control device or a right movement command corresponding to a right movement button input of the remote control device.

11. The display device of claim 1, wherein the processor is configured to:
move to a channel corresponding to the channel change command and play a content corresponding to a highest priority among a content list of the moved channel.

12. The display device of claim 11, wherein the processor is configured to:
play a live sports content with a highest priority among the content list of the moved channel, if a user-preferred category of the moved channel is sport.

13. The display device of claim 1, wherein the processor is configured to:
determine whether a channel adjacent to a channel on which content is being played is a user-preferred content provider channel, and if the channel adjacent is a user-preferred content provider, execute an application of the content provider of the channel adjacent in a background.

14. The display device of claim 13, wherein the processor is configured to:
perform automatic login for a user ID in the application running in the background and perform preload for each content in a content list of the channel adjacent.
